(19) United States
(12) Patent Application Publication
(10) Pub. No.: US 2016/0210376 A1
(43) Pub. Date: Jul. 21, 2016

(54) ELEVATOR FACILITY PLANNING SUPPORT APPARATUS

(71) Applicant: Mitsubishi Electric Corporation, Chiyoda-ku (JP)

(72) Inventor: Naohiko SUZUKI, Tokyo (JP)

(73) Assignee: Mitsubishi Electric Corporation, Chiyoda-ku (JP)

(21) Appl. No.: 14/740,543

(22) Filed: Jun. 16, 2015

(30) Foreign Application Priority Data
Jan. 20, 2015 (JP) 2015-008291

(51) Int. Cl. G06F 17/50

(52) U.S. Cl. CPC G06F 17/5004

(57) ABSTRACT

An elevator facility planning support apparatus according to the present invention includes: a traffic demand receiver receiving the number of arriving passengers per unit time; an elevator specifications receiver receiving facility specifications of the elevator; a round trip time equation creating unit creating a round trip time equation that indicates that a round trip time is equal to the sum of a shuttle travel time required for the elevator to go to a reversal floor and back, a stop time of the elevator on served floors, and a boarding-and-alighting time for passengers on the served floors; and a round trip time computing unit computing the round trip time from the round trip time equation. In the round trip time equation, the round trip time is expressed by a function that includes, as variables, the number of arriving passengers per unit time and the round trip time.

### BACKGROUND OF THE INVENTION

1. Field of the Invention

The present invention relates to an apparatus that supports decisions about the specifications of elevators to be installed, such as the number of elevators, the passenger capacity, or the speed, depending on the number of floors and the traffic demand in a target building.

2. Description of the Background Art

The specifications of elevators to be installed in a building, such as the number of elevators, the passenger capacity, or the speed are determined depending on the number of floors and the traffic demand in the building. The above-described specifications have been conventionally determined for the traffic pattern during commuting hours in which travels from the lobby floor (reference floor) to the upper floors are dominant (for example, Japanese Patent Application Laid-Open No. 2012-106849 and Japanese Patent Application Laid-Open No. 09-295772 (1997)). For the traffic pattern during the time period other than the commuting hours, each index to be used in computations has been calculated using its ratio to the index for the commuting hours, to thereby perform the computations (for example, Gina Carol Barney, “Elevator Traffic Handbook: Theory and Practice,” pp. 323-334, Taylor & Francis, 2004).

The methods according to Japanese Patent Application Laid-Open No. 2012-106849 and Japanese Patent Application Laid-Open No. 09-295772 (1997), which are intended for the traffic pattern during the commuting hours, are unfortunately difficult to apply to the traffic pattern during the time period other than the commuting hours because the elevator needs to serve not only the lobby floor but also a plurality of boarding floors for travels in different directions. The method according to Gina Carol Barney, “Elevator Traffic Handbook: Theory and Practice,” pp. 323-334, Taylor & Francis, 2004 has difficulties in preparing the index ratio that is flexibly adapted to the specifications of the building or to the specifications of the elevators. This makes it difficult to determine the specifications of the elevators by properly evaluating the traffic conditions.

### SUMMARY OF THE INVENTION

The present invention has an object to provide an elevator facility planning support apparatus that properly evaluates a traffic demand in a building with the assumption that a plurality of boarding floors are served by an elevator.

An elevator facility planning support apparatus according to the present invention supports facility planning for an elevator in a building and includes: a traffic demand receiver receiving the number of arriving passengers per unit time as a traffic demand in the building; an elevator specifications receiver receiving facility specifications of the elevator; a processor configured to execute a program; and a memory that stores the program which, when executed by the processor, results in performance of steps including, creating a round trip time equation that indicates that a round trip time required for the elevator to make a round trip of departing from a reference floor, turning around on a reversal floor, and returning to the reference floor is equal to the sum of a shuttle travel time required for the elevator to go to the reversal floor and back, a stop time of the elevator on served floors, and a boarding-and-alighting time for passengers on the served floors, and computing the round trip time from the round trip time equation. In the round trip time equation, the round trip time is expressed by a function that includes, as variables, the number of arriving passengers per unit time and the round trip time. The elevator facility planning support apparatus supports the facility planning for the elevator on the basis of the round trip time.

In the round trip time equation, a round trip time RTT is a function of the number of arriving passengers pp per unit time and the round trip time RTT. Thus, the round trip time can be computed for the traffic pattern in which a large number of boarding floors are served.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a traffic pattern of an elevator during commuting hours;

FIG. 2 illustrates a traffic pattern of the elevator that serves a large number of boarding floors;

FIGS. 3A, 3B, and 3C illustrate a relation between a round trip time and the number of passengers in the traffic pattern of the elevator that serves a large number of boarding floors;

FIG. 4 is a block diagram illustrating a configuration of an elevator facility planning support apparatus;

FIG. 5 illustrates an elevator system to be supported by an elevator facility planning support apparatus according to a first preferred embodiment;

FIGS. 6A and 6B illustrate redundancy elimination processing in elevator group control;

FIG. 7 illustrates the redundancy elimination processing in the elevator group control; and

FIG. 8 illustrates an elevator system to be supported by the elevator facility planning support apparatus according to a third preferred embodiment.

### DESCRIPTION OF THE PREFERRED EMBODIMENTS

<A. Underlying Technique>

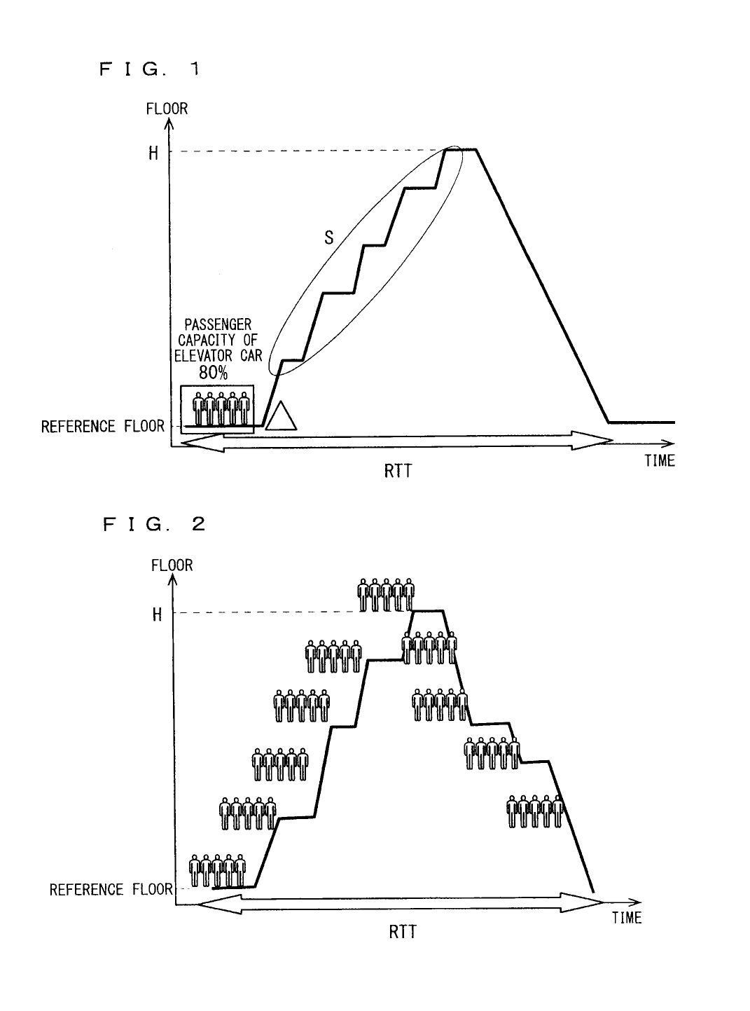

FIG. 2 illustrates an example of the round trip time computation method that is applicable to a traffic pattern during commuting hours. It is assumed that the number of users arriving in, for example, an office building reaches its peak during commuting hours, providing a traffic pattern in which a large number of passengers take an elevator on the lobby floor (reference floor). FIG. 1 illustrates such traffic pattern. That is, the elevator picks up, on the lobby floor, passengers corresponding to a given ratio to the passenger capacity of the elevator car, stops at a large number of destination floors to discharge the passengers, and then returns to the lobby floor. An elevator facility planning support apparatus computes such duration of time as a round trip time, to thereby obtain the maximum number of passengers to be carried per unit time.

In particular, assuming that passengers corresponding to 80% of the passenger capacity of the car take an elevator on the lobby floor, Expression (1) represents the expected value of the number of floors S served by the car in response to car calls, Expression (2) represents the expected value of a reversal floor H, and Expression (3) represents a round trip time RTT (Gina Carol Barney, “Elevator Traffic Handbook: Theory and Practice,” pp. 104-107, Taylor & Francis, 2004).

$$\begin{matrix}S = N \{ 1 - {( \frac{N - 1}{N} )}^{P} \} & ( 1 ) \\ H = N - {\sum }_{i = 1}^{N - 1} {( \frac{i}{N} )}^{P} & ( 2 ) \\ RTT = 2 {Ht}_{v} + ( S + 1 ) {t}_{s} + 2 {Pt}_{p} & ( 3 )\end{matrix}$$

In these expressions, S represents the number of served floors and N represents the number of floors above the lobby floor (reference floor). P represents the number of passengers getting into the car and is set at 80% of the passenger capacity of the car. H represents the reversal floor, RTT represents the round trip time, tᵥ represents the time required for the elevator to travel per floor, tₛ represents the time required per stop, and tₚ represents the boarding time or the alighting time. The number of passengers getting into the car on the lobby floor is determined from these expressions, so that the round trip time and the maximum number of passengers to be carried are uniquely provided. Note that this traffic calculation is based on significantly heavy load conditions assuming that the queue of passengers corresponding to 80% or more of the passenger capacity of the car is constantly formed on the lobby floor.

During a time period other than the commuting hours, for example, during lunchtime, a large number of boarding floors need to be served as shown in FIG. 2. Thus, unlike in the traffic pattern shown in FIG. 1, hall calls are expected to be issued from a large number of floors. Unfortunately, the specific number of such hall calls cannot be uniquely determined, making it difficult to determine the number of served floors S, the reversal floor H, and the round trip time RTT simply from Expressions (1) to (3).

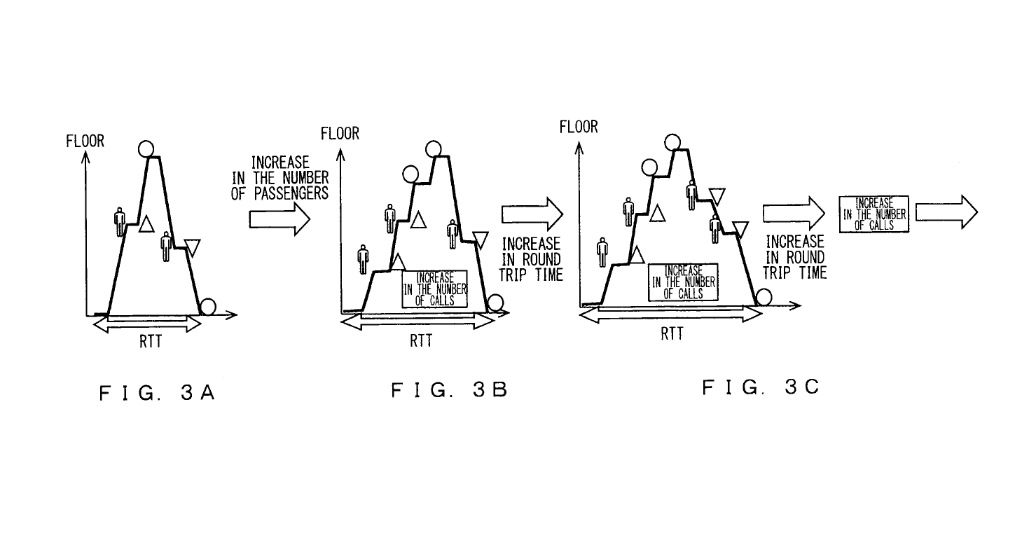

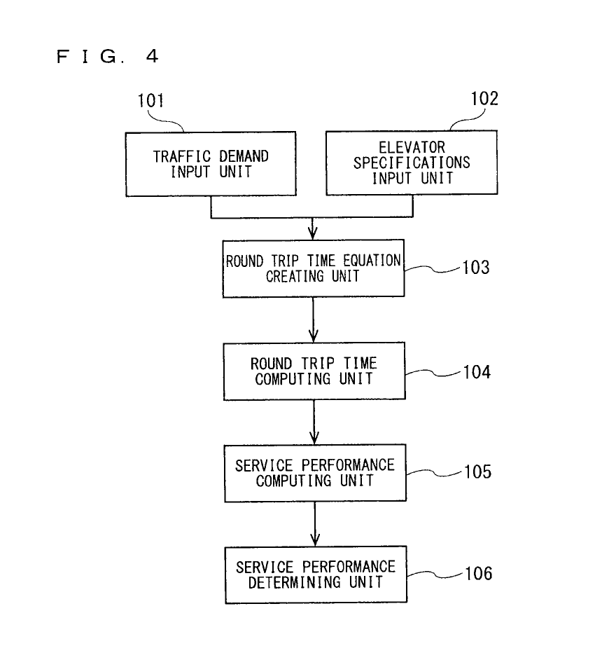

FIGS. 3A, 3B, and 3C illustrate the relation between the round trip time and the number of calls assuming that a large number of boarding floors are served and the number of arriving passengers per unit time is constant. FIG. 3A illustrates the traffic pattern in which the elevator makes a stop on one floor before and after turning around on the reversal floor. Then, the number of calls increases with the increasing number of passengers as shown in FIG. 3B. FIG. 3B shows a state in which the elevator has two more floors to serve before turning around on the reversal floor. The round trip time increases with the increasing number of served floors. This causes a further increase in the number of calls as shown in FIG. 3C. FIG. 3C shows a state in which the elevator has one more floor to serve after turning around on the reversal floor. The increase in the number of calls causes an increase in the round trip time, resulting in a further increase in the number of calls.

In a case where a large number of boarding floors are served, meanwhile, the number of passengers getting into the elevator exceeds the passenger capacity of the car, making it difficult to apply the assumption that passengers corresponding to 80% of the passenger capacity get into the elevator from the elevator hall as described above. Thus, the important task in computing the round trip time is to find a point in which the round trip time and the number of hall calls are in balance.

<B. First Preferred Embodiment>

<B-1. Configuration>

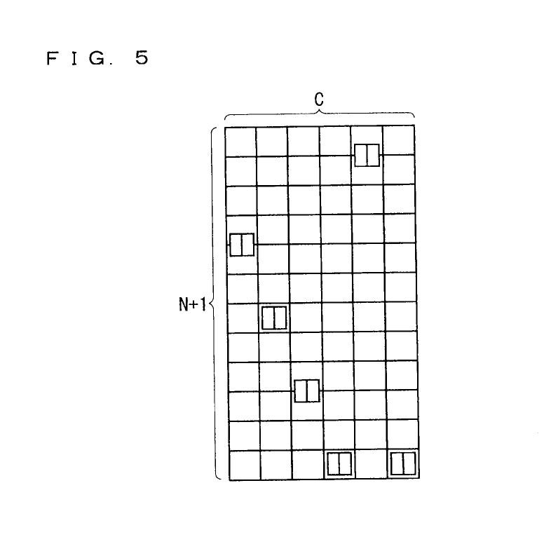

FIG. 4 is a block diagram illustrating a configuration of the elevator facility planning support apparatus according to a first preferred embodiment. An elevator facility planning support apparatus 1 includes a traffic demand receiver 101, an elevator specifications receiver 102, a round trip time equation creating unit 103, a round trip time computing unit 104, a service performance computing unit 105, and a service performance determining unit 106.

The traffic demand receiver 101 receives, for example, the number of floors, the floor height, or the predicted traffic demand in a building (hereinafter referred to as “target building”) for which an elevator facility plan is created.

The elevator specifications receiver 102 receives the specifications of elevators to be installed in the target building. The specifications of the elevators include the number of elevators, the passenger capacity, the speed, and the group control method.

The round trip time equation creating unit 103 creates a round trip time equation on the basis of the results received by the traffic demand receiver 101 and the elevator specifications receiver 102. The round trip time equation derives the round trip time of the elevator as described below.

The round trip time computing unit 104 computes the round trip time from the round trip time equation created by the round trip time equation creating unit 103.

The service performance computing unit 105 computes service performance indices, such as the average departure interval or the average waiting time, from the round trip time computed by the round trip time computing unit 104.

The service performance determining unit 106 determines whether the service performance indices computed by the service performance computing unit 105 satisfy the performance criteria.

<B-2. Creation of Round Trip Time Equation>

Expressions (4) to (6) shown below represents the round trip time equations created by the round trip time equation creating unit 103. FIG. 5 illustrates a configuration of the elevators and the building to be supported by the elevator facility planning support apparatus according to the first preferred embodiment. The total number of floors in the building is represented by N+1 and the number of elevators is represented by C. Expressions (4) to (6) are intended for the traffic pattern of travels from a large number of boarding floors above the reference floor to the reference floor assuming that the floors above the reference floor have the same passenger arrival rate.

$$\begin{matrix}RTT = 2 {Ht}_{v} + ( S + 1 ) {t}_{s} + 2 {Pt}_{p} & ( 4 ) \\ S = N \{ 1 - {( \frac{N - 1}{N} )}^{pp * RTT} \} & ( 5 ) \\ H = N - {\sum }_{i = 1}^{N - 1} {( \frac{i}{N} )}^{pp * RTT} & ( 6 )\end{matrix}$$

In Expression (4), which is described in the same form as Expression (3), the round trip time RTT is expressed by: the term indicating the shuttle time required for the elevator to travel from the reference floor to the reversal floor and to return to the reference floor; the term indicating the stop time that is the product of the number of served floors and the time required per stop; and the term indicating the boarding and alighting time for passengers. The time required for the elevator to travel per floor is denoted by tᵥ and is computed by the round trip time equation creating unit 103 on the basis of the elevator speed received by the elevator specifications receiver 102 and the building floor height received by the traffic demand receiver 101. The time required per stop is denoted by tₛ and is computed by the round trip time equation creating unit 103 on the basis of the speed, the acceleration, and the deceleration of the elevator that are received by the elevator specifications receiver 102. The number of arriving passengers per unit time that is received by the traffic demand receiver 101 is denoted by pp. The boarding time or the alighting time required per passenger is denoted by tₚ and is received by the elevator specifications receiver 102.

Expression (5) represents the expected value of the number of served floors. In Expression (1), an exponent P represents the fixed ratio to the passenger capacity of the car. Alternatively, Expression (5) includes, as the exponent, the product of the number of arriving passengers pp per unit time and the round trip time RTT. Expression (5) except for the above part is the same as Expression (1). The number of floors above the reference floor is denoted by N and is computed by the round trip time equation creating unit 103 from the number of building floors that is received by the traffic demand receiver 101.

Expression (6) represents the expected value of the reversal floor. In Expression (2), the exponent P represents the fixed ratio to the passenger capacity of the car. Alternatively, Expression (6) includes, as the exponent, the product of the number of arriving passengers pp per unit time and the round trip time RTT. Expression (6) except for the above part is the same as Expression (2).

The round trip time equation creating unit 103 substitutes the above-described parameters tᵥ, tₛ, pp, tₚ, and N into Expressions (4) to (6), to thereby create the round trip time equations.

<B-3. Computation of Round Trip Time Equations>

The following describes a method for computing the round trip time through the round trip time computing unit 104. The left-hand side of Expression (4) is the round trip time RTT to be obtained. In addition, each term on the right hand-side of Expression (4) is the function of the round trip time RTT. Thus, RTT is difficult to obtain directly, so that an approximate solution to RTT is obtained. The following describes an example of the derivation of the approximate solution in accordance with the Newton's method. To compute RTT, the methods other than the Newton's method, such as the bisection algorithm, may be applied or a simulation may be used.

Expression (7) represents a function f(x) obtained by substituting x for RTT in Expression (4) and modifying Expression (4) such that 0 is provided on the left-hand side and then the left-hand side is expressed by f(x). In Expression (7), the reversal floor H and the number of served floors S are the functions of x, and therefore, are denoted by H(x) and S(x), respectively.

f(x)=−x+2H(x)tᵥ+(S(x)+1)tₛ+2Ptₚ (7)

Computations are performed to find x satisfying the expression f(x)=0. In accordance with the Newton's method, firstly, an initial value xo is selected and an intersection point x1 of the x axis and the tangent line of f(x) under the condition of x=xo is obtained. Next, an intersection point x2 of the x axis and the tangent line of f(x) under the condition of x=x1 is obtained. Then, computations are successively performed in accordance with the recurrence formula shown below as Expression (8), so that Xₙ converges to x satisfying the condition of f(x)=0. When the appropriate number of computations or the error that is used as the reference is provided, the computations are ended. Consequently, the approximate solution to x satisfying the condition of f(x)=0 is obtained.

$${x}_{n + 1} = {x}_{n} - \frac{f ( {x}_{n} )}{{f}^{′} ( {x}_{n} )} \qquad ( 8 )$$

<B-4. Service Performance>

The service performance computing unit 105 computes the values that indicate the service performance including the average departure interval, the average waiting time, and the average number of passengers on the basis of the round trip time computed by the round trip time computing unit 104. Dividing the round trip time by the number of elevators provides the average departure interval. An average waiting time WT is represented by Expression (9) shown below.

$$WT = {\sum }_{i = 1}^{m} \frac{1}{m} \cdot \frac{2 i - 1}{2 C} RTT \qquad ( 9 )$$

In Expression (9), m represents the number of elevators to which the calls issued within the temporal proximity are allocated and the calculation is preformed assuming that, for example, m=C.

The average number of passengers is obtained in accordance with (pp·RTT)/(k·C). In this expression, the number of elevators is denoted by C and is received by the elevator specifications receiver 102. Meanwhile, k is the parameter that depends on the proportion between the passengers traveling in the upward direction and the passengers traveling in the downward direction and is obtained from the predicted traffic demand received by the traffic demand receiver 101. For example, in a case where all of the passengers traveling from the upper floors descend to the reference floor, k is equal to 1. In a case where the number of passengers traveling from the reference floor to the upper floors is equal to the number of passengers traveling from the upper floors to the reference floor, k is equal to 2. Under the condition of k=1, the total number of passengers per round trip is divided by the number of cars, whereby the average number of passengers is provided.

The service performance determining unit 106 evaluates the service performance computed by the service performance computing unit 105. For example, the service performance determining unit 106 determines whether the average waiting time is equal to or less than the performance criterion of 20 seconds. If the criterion is not met, the service performance determining unit 106 determines that the elevator specifications received by the elevator specifications receiver 102 are insufficient.

The service performance may be determined on the basis of the transport capacity per unit time or on the round trip time. Unlike in the traffic pattern during commuting hours, without the assumption that a large number of passengers constantly arrive on the reference floor, such as the lobby floor, the passenger capacity of the car is not included in the round trip time equations according to Expressions (4) to (6). Consequently, the transport capacity per unit time cannot be calculated. Thus, in a case where a large number of boarding floors are served, calls are allocated to a plurality of cars, allowing the service performance to be determined on the basis of the average waiting time.

The service performance computing unit 105 determines whether the elevator is capable of accommodating passengers without reaching its passenger capacity. The round trip time equations represented by Expressions (4) to (6) do not include the term indicating the passenger capacity of the car. Consequently, Expressions (4) to (6) hold for the case in which the average number of passengers exceeds the passenger capacity of the car. Thus, the number of passengers getting into the elevator is limited as shown in Expression (10).

$$\frac{pp \cdot RTT}{k \cdot C} \leq 0.8 R \qquad ( 10 )$$

If the round rip time RTT obtained from Expressions (4) to (6) do not meet the condition of Expression (10), the car fails to accommodate the arriving passengers. Thus, the target facility planning is determined to be inappropriate. According to Expression (10), if the average number of passengers is equal to or less than 80% of the passenger capacity of the car, all of the passengers can get into the car. Thus, the car is determined to be capable of accommodating passengers.

<B-5. Modifications>

According to Expressions (4) to (6), both the number of served floors S and the reversal floor H include the number of arriving passengers pp per unit time and the round trip time RTT as variables. Alternatively, one of the number of served floors S and the reversal floor H may include the number of arriving passengers pp per unit time and the round trip time RTT as variables. The other one of the number of served floors S and the reversal floor H may be derived from Expression (1) or Expression (2).

In Expressions (4) to (6), any of the upper floors has the equal passenger arrival rate. Unfortunately, in some buildings, the number of users varies from floor to floor, and thus, the passenger arrival rate significantly differs from floor to floor. In this is the case, computations may be performed assuming that the passenger arrival rate is not equal for all of the upper floors. In this case, Expressions (5) and (6) are modified such that the passenger arrival rate on the i-th floor is expressed as Uᵢ/U (the sum total of Uᵢ is U), whereby the number of served floors S and the reversal floor H are represented by Expressions (11) and (12) below, respectively.

$$\begin{matrix}S = N \{ 1 - \frac{1}{N} {\sum }_{i = 1}^{N} {( 1 - \frac{{U}_{i}}{U} )}^{pp * RTT} \} & ( 11 ) \\ H = N - {\sum }_{j = 1}^{N - 1} {[ {\sum }_{i = 1}^{j} ( \frac{{U}_{i}}{U} ) ]}^{pp * RTT} & ( 12 )\end{matrix}$$

<B-6. Effects>

The elevator facility planning support apparatus according to the first preferred embodiment includes the traffic demand receiver 101, the elevator specifications receiver 102, the round trip time equation creating unit 103, and the round trip time computing unit 104. The traffic demand receiver 101 receives the number of arriving passengers pp per unit time as a traffic demand in the building. The elevator specifications receiver 102 receives facility specifications of the elevator. The round trip time equation creating unit 103 creates the round trip time equation that indicates that the round trip time RTT required for the elevator to make a round trip of departing from the reference floor, turning around on the reversal floor H, and returning to the reference floor is equal to the sum of the shuttle travel time required for the elevator to go to the reversal floor H and back, the stop time of the elevator on the served floors, and the boarding-and-alighting time for passengers on the served floors. The round trip time computing unit 104 computes the round trip time RTT from the round trip time equation. The elevator facility planning support apparatus supports the facility planning for the elevator on the basis of the round trip time RTT computed by the round trip computing unit 104. In particular, the round trip time equation has the round trip time RTT that is the function of the number of arriving passengers pp per unit time and the round time RTT, thereby allowing calculation of the round trip time for the traffic pattern in which a large number of boarding floors are served.

In the round trip time equation, the stop time is the function of the number of served floors S, the shuttle travel time is the function of the reversal floor H, and at least one of the number of served floors S and the reversal floor H is the function of the number of arriving passengers pp per unit time and the round trip time RTT. Thus, the round trip time can be computed for the traffic pattern in which a large number of boarding floors are served.

The elevator facility planning support apparatus according to the first preferred embodiment includes the service performance computing unit 105 that computes the service performance of the elevator on the basis of the round trip time RTT computed by the round trip time computing unit 104, to thereby support the elevator facility planning for the elevator on the basis of the service performance. Thus, the service performance can be computed for the traffic pattern in which a large number of boarding floors are served.

The elevator facility planning support apparatus according to the first preferred embodiment further includes the service performance determining unit 106 that determines whether the service performance meets the predetermined reference value, to thereby support the elevator facility planning for the elevator on the basis of the determination results provided by the service performance determining unit 106. Thus, the service performance can be evaluated for the traffic pattern in which a large number of boarding floors are served, providing the determination whether the specifications of the elevator are sufficient for the elevator installation planning.

The elevator specifications receiver 102 receives the passenger capacity of the elevator as the facility specifications and the service performance determining unit 106 determines whether the elevator is capable of accommodating passengers without reaching its passenger capacity on the basis of the passenger capacity of the elevator, the round trip time, and the number of arriving passengers per unit time. This allows the determination whether the elevator is actually capable of accommodating passengers in view of the passenger capacity of the elevator for the traffic pattern in which a large number of boarding floors are served.

<C. Second Preferred Embodiment>

<C-1. Operation>

The elevator facility planning support apparatus according a second preferred embodiment computes the round trip time with consideration given to the effects of an elevator group control system. Although the elevator facility planning support apparatus according the second preferred embodiment has the configuration similar to that of the elevator facility planning support apparatus according to the first preferred embodiment shown in FIG. 4, the round trip time equation creating unit 103 operates slightly differently as described below.

In a case where a large number of boarding floors are served, the elevator group control system performs a control such that the passengers who arrive on the same floor within the temporal proximity and attempt to travel in the same direction are allocated to a single elevator instead of being allocated to different elevators, to thereby increase the operation efficiency. Thus, the facility planning for a plurality of elevators requires consideration of redundant hall calls.

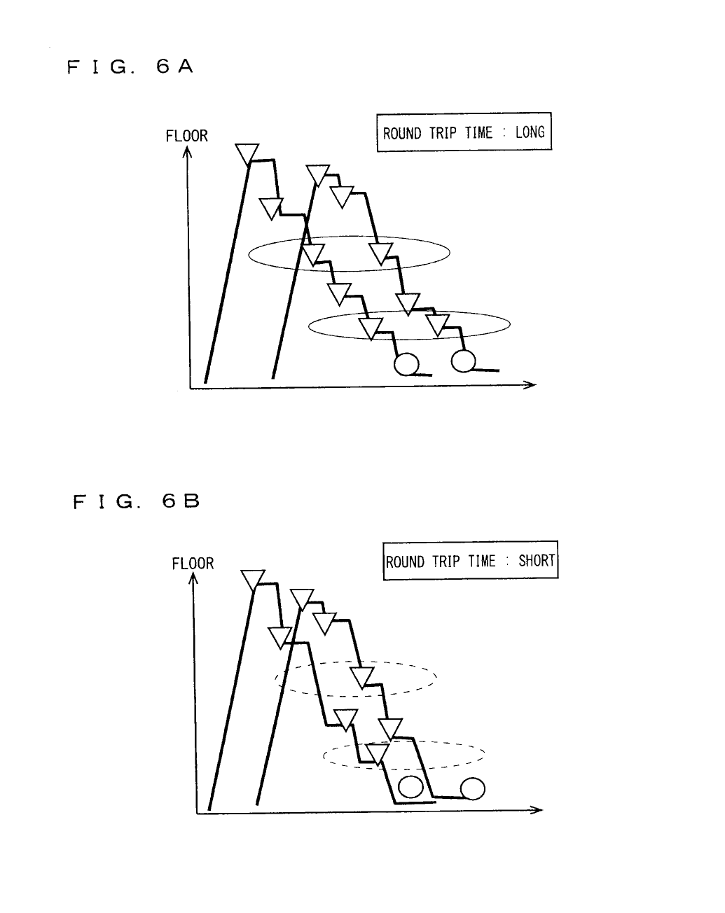

FIGS. 6A and 6B illustrate the state in which two elevators run in the same direction one after another. As shown in FIG. 6A, when both of the two elevators redundantly receive hall calls from the same floor, the round trip time increases, which deteriorates the operation efficiency. Thus, in accordance with the elevator group control, call allocations are determined such that only one of the elevators stops on the floor from which the hall calls are redundantly issued (FIG. 6B). Similarly, the correction of the number of floors served by the elevators is illustrated in FIG. 7, in which S is changed to S−1 through the redundancy elimination processing.

The round trip time equation creating unit 103 according to the second preferred embodiment creates the round trip time equations with consideration given to the redundant hall calls described above. In particular, an expected value S_{L} of the number of floors redundantly served by the two elevators is firstly obtained from Expressions (13) and (14).

$$\begin{matrix}{S}_{L} = {\sum }_{n = 0}^{S} n \frac{{C}_{n}^{S} {C}_{S - n}^{F - S}}{{C}_{S}^{F}} & ( 13 ) \\ {C}_{S}^{F} = \frac{F !}{S ! ( F - S ) !} & ( 14 )\end{matrix}$$

Expression (14) represents the number of combinations for obtaining the number of floors S from the number of floors F. In Expression (13), the expected value S_{L} of the number of redundantly served floors is computed in accordance with the probability that n is obtained from the number of served floors S and S−n is obtained from the number of floors F−S for the case where the number of served floors S is obtained from the number of floors F.

The number of served floors S obtained from Expression (5) is a real number. Consequently, in Expressions (13) and (14), the expected value S_{L} of the number of served floors cannot be calculated as the general factorial of an integer. Thus, a gamma function Γ(z) in Expression (15), which is the function indicating the factorial of a real number, is used to compute the factorial of the real number in Expressions (13) and (14).

Z!=Γ(z+1)=∫₀^{∞}t^{Z}e⁻¹dt (15)

The round trip time equation creating unit 103 corrects the number of served floors S and the round trip time RTT as shown in Expressions (16) and (17) using the expected value S_{L} of the number of redundantly served floors that is obtained from Expression (13). Expression (16) represents a corrected number of served floors S′ and Expression (17) represents a corrected round trip time RTT′.

$$\begin{matrix}{S}^{′} = S - \frac{1}{2} {S}_{L} & ( 16 ) \\ {RTT}^{′} = 2 {Ht}_{v} + ( {S}^{′} + 1 ) {t}_{s} + 2 {Pt}_{P} & ( 17 )\end{matrix}$$

In Expression (16), the number of served floors S is corrected such that only one elevator stops on the floor from which calls are redundantly issued. The above description, which has been given on the case where the hall calls are redundantly received by the two elevators, holds true for the case with consideration given to the hall calls redundantly received by three or more elevators.

In a case where a large number of boarding floors are served, the round trip time equations created as described above allow computations of the round trip time suited to the actual operation with consideration given to the redundancy elimination processing for hall calls in the elevator group control system.

<C-2. Effects>

In the elevator facility planning support apparatus according to the second preferred embodiment, the round trip time equation creating unit 103 computes the expected value S_{L} of the number of floors redundantly served by the elevator and creates the round trip time equations using the number of served floors S′ that is corrected on the basis of the computation results. This allows calculation of the round trip time suited to the actual operation with consideration given to the function of the elevator group control apparatus that collectively assigns the hall calls issued from the same floor to a single elevator.

<D. Third Preferred Embodiment>

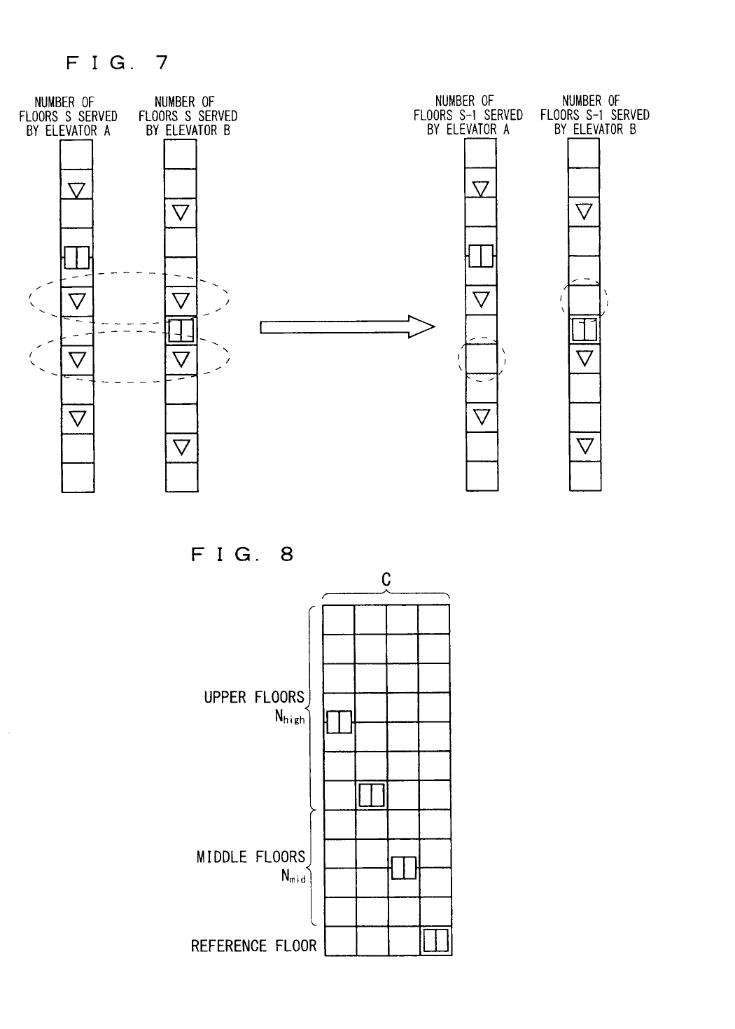

FIG. 8 illustrates a configuration of the elevators and the building to be supported by the elevator facility planning support apparatus according to a third preferred embodiment. The floors of the building are divided into three zones including a reference floor (lobby floor), a middle zone, and an upper zone. The lobby floor includes only one floor and the middle zone and the upper zone each include a plurality of floors. In typical office buildings, travels between the lobby floor and each of the upper floors are dominant as the traffic demand. Meanwhile, the elevator facility planning for buildings intended for various purposes needs to deal with travels between any two of the plurality of zones that are provided as the constant traffic demand. Thus, in the third preferred embodiment, the round trip time is computed with consideration given to travels between any two of the plurality of zones.

<D-1. Operation>

The elevator facility planning support apparatus according to the third preferred embodiment has the configuration similar to that of the elevator facility planning support apparatus according to the first preferred embodiment shown in FIG. 4. Note that the traffic demand receiver 101 receives, as a traffic demand, the number of arriving passengers per unit time in each zone for each of the upward and downward travel directions separately from each other. The round trip time equation creating unit 103 creates the round trip time equations on the basis of the number of arriving passengers per unit time in each zone for each travel direction.

The expression of the round trip time RTT, which is one of the round trip time equations, is the same as Expression (4). The number of served floors S is represented by Expression (18) below.

S=s(UP,mid)+s(UP,high)+s(DOWN,mid)+s(DOWN,high)+1 (18)

In the above expression, the number of floors in the middle zone that are served by the ascending elevator is denoted by s (UP, mid) and the number of floors in the upper zone that are served by the ascending elevator stops is denoted by s (Up, high). The number of floors in the middle zone that are served by the descending elevator stops is denoted by s (DOWN, mid) and the number of floors in the upper zone that are served by the descending elevator stops is denoted by s (DOWN, high).

The number of served floors in each of the middle zone and the upper zone for each direction is represented by Expressions (19) to (22). The number of served floors in each zone for each of the upward and downward travel directions can be expressed by the number of floors in each zone and the number of arriving passengers per unit time in each zone.

$$\begin{matrix} s ( UP , mid ) = {N}_{mid} \{ 1 - ( \frac{{N}_{mid} - 1}{{N}_{mid}} ) \text{?} \} & ( 19 ) \\ s ( UP , high ) = {N}_{high} \{ 1 - ( \frac{{N}_{high} - 1}{{N}_{high}} ) \text{?} \} & ( 20 ) \\ s ( DOWN , mid ) = {N}_{mid} \{ 1 - ( \frac{{N}_{mid} - 1}{{N}_{mid}} ) \text{?} \} & ( 21 ) \\ s ( DOWN , high ) = {N}_{high} \{ 1 - ( \frac{{N}_{high} - 1}{{N}_{high}} ) \text{?} \} \\ \text{?} \text{indicates text missing or illegible when filed} & ( 22 )\end{matrix}$$

In the above expressions, the number of floors in the middle zone is denoted by N_{mid} and the number of floors in the upper zone is denoted by N_{high}. The number of arriving passengers per unit time for the traffic from the lobby floor to the middle zone is denoted by pp_{LM} and the number of arriving passengers per unit time for the traffic from the lobby floor to the upper zone is denoted by pp_{LH}. The number of arriving passengers per unit time for the traffic from the middle zone to the lobby floor is denoted by pp_{ML}, the number of arriving passengers per unit time in the traffic within the middle zone is denoted by pp_{MM}, and the number of arriving passengers per unit time for the traffic from the middle floors to the upper zone is denoted by pp_{MH}. The number of arriving passengers per unit time for the traffic from the upper zone to the lobby floor is denoted by pp_{HL}, the number of arriving passengers per unit time for the traffic from the upper floors to the middle zone is denoted by pp_{HM}, and the number of arriving passengers per unit time in the traffic within the upper zone is denoted by pp_{HH}.

The reversal floor H is represented by Expression (23) shown below. This expression includes the number of arriving passengers per unit time for the traffic to or from the upper zone, to thereby compute the expected value of the reversal floor.

$$H = {N}_{high} + {N}_{mid} + 1 - {\sum }_{i = 1}^{{N}_{high} - 1} ( \frac{i}{N} ) \text{?} \\ \text{?} \text{indicates text missing or illegible when filed} \qquad ( 23 )$$

Then, the number of served floors S and the reversal floor H obtained from Expressions (18) to (23) are substituted into Expression (4), so that the round trip time equation is provided.

The above description, which has been given on the round trip time equations for the building in which the floors are divided into three layers, holds true for the round trip time equations for buildings in which the floors are divided into two, four, or more layers.

<D-2. Effects>

In the elevator facility planning support apparatus according to the third preferred embodiment, the traffic demand receiver 101 receives the number of arriving passengers per unit time for every two of the plurality of zones separately from each other that are obtained by dividing the floors in the building. The round trip time equations are created with consideration given to the difference in the number of arriving passengers for every two of the plurality of zones, allowing more accurate calculation of the round trip time.

While the invention has been shown and described in detail, the foregoing description is in all aspects illustrative and not restrictive. It is therefore understood that numerous modifications and variations can be devised without departing from the scope of the invention.

What is claimed is:

1. An elevator facility planning support apparatus that supports facility planning for an elevator in a building, said apparatus comprising:
a traffic demand receiver receiving said number of arriving passengers per unit time as a traffic demand in the building;
an elevator specifications receiver receiving facility specifications of said elevator;
a processor configured to execute a program; and
a memory that stores the program which, when executed by the processor, results in performance of steps comprising,
creating a round trip time equation that indicates that a round trip time required for said elevator to make a round trip of departing from a reference floor, turning around on a reversal floor, and returning to said reference floor is equal to the sum of a shuttle travel time required for said elevator to go to said reversal floor and back, a stop time of said elevator on served floors, and a boarding-and-alighting time for passengers on said served floors, and
computing said round trip time from said round trip time equation, wherein
in said round trip time equation, said round trip time is expressed by a function that includes, as variables, said number of arriving passengers per unit time and said round trip time, and
said elevator facility planning support apparatus supports the facility planning for said elevator on the basis of said round trip time.

2. The elevator facility planning support apparatus according to claim 1, wherein in said round trip time equation,
said stop time is a function of the number of said served floors,
said shuttle travel time is a function of said reversal floor, and
at least one of the number of said served floors and said reversal floor is a function of said number of arriving passengers per unit time and said round trip time.

3. The elevator facility planning support apparatus according to claim 1, wherein
said program which, when executed by said processor, results in performance of steps further comprising computing service performance of said elevator on the basis of said round trip time, and
said elevator facility planning support apparatus supports the facility planning for said elevator on the basis of said service performance.

4. The elevator facility planning support apparatus according to claim 3, wherein
said program which, when executed by said processor, results in performance of steps further comprising determining whether said service performance meets a predetermined reference value, and
said elevator facility planning support apparatus supports the facility planning for said elevator on the basis of determination results.

5. The elevator facility planning support apparatus according to claim 4, wherein
said elevator specifications receiver receives a passenger capacity of said elevator as said facility specifications, and
in said determining, whether said elevator is capable of accommodating passengers without reaching its passenger capacity is determined in accordance with the passenger capacity of said elevator, said round trip time, and said number of arriving passengers per unit time.

6. The elevator facility planning support apparatus according to claim 1, wherein
in said creating, an expected value of the number of floors redundantly served by said elevator is computed, and
said round trip time equation is created using the number of said served floors that is corrected on the basis of results of the computation.

7. The elevator facility planning support apparatus according to claim 1, wherein said traffic demand receiver receives the number of arriving passengers per unit time for every two of a plurality of zones separately from each other, said plurality of zones being obtained by dividing floors in the building.
